(19) United States
(12) Patent Application Publication
(10) Pub. No.: US 2005/0272307 A1
(43) Pub. Date: Dec. 8, 2005

(54) Mounting element

(76) Inventor: Wei-Chen Chen, Taipei (TW)

Correspondence Address: CAESAR, RIVISE, BERNSTEIN,;COHEN & POKOTILOW, LTD., 11TH FLOOR, SEVEN PENN CENTER, 1635 MARKET STREET, PHILADELPHIA, PA, 19103-2212, US

(21) Appl. No.: 10/858,789

(22) Filed: Jun. 2, 2004

(51) Int. Cl. H01R 12/00

(52) U.S. Cl. 439/566

(57) ABSTRACT

A mounting element includes a main body made of metal and having opposite first and second ends, and a soldering portion disposed adjacent to the first end and adapted to be soldered onto a substrate. The second end is adapted for supporting a device thereon. The soldering portion has a roughened outer surface.

### BACKGROUND OF THE INVENTION

1. Field of the Invention

The invention relates to a mounting element, more particularly to a mounting element that can be securely soldered onto a substrate.

2. Description of the Related Art

Referring to FIG. 1, a heat sink 11 is to be mounted on a circuit board 13 for dissipating heat generated by a CUP 12 on the circuit board 13 by means of a plurality of screws 16, each of which is fastened into a conventional mounting element, such as a nut 14, soldered onto the circuit board 13. During the assembly operation of the nut 14, each nut 14 is disposed on a solder paste 15 such that, after passing through a solder furnace, the nuts 14 are thus fixed on the circuit board 13. FIG. 2 illustrates the heat sink 11 when assembled to the circuit board 13 that is provided with the nuts 14. Each nut 14 has a soldering end portion having a smooth outer surface and soldered onto the circuit board 13.

FIG. 3 illustrates the heat sink 11 when assembled to a circuit board 13′ that is provided with another set of nuts 14′. Each nut 14′ also includes a soldering end portion having a smooth outer surface and soldered onto the circuit board 13′. Each nut 14′ further includes an anchor body that extends from the soldering end portion and that extends into a recess in the circuit board 13′.

Since the outer surface of the soldering end portion of each nut 14, 14′ is smooth, the solder paste 15 cannot stick firmly onto the outer surface of the soldering end portion such that secured mounting of the nuts 14, 14′ on the circuit board 13, 13′ cannot be ensured. Therefore, during assembly of the heat sink 11, the nuts 14, 14′ may break off as a result of an external torque when tightening of the screws 16. As a result, an auxiliary tool (not shown) is needed to hold the nuts 14, 14′ when assembling of the heat sink 11.

### SUMMARY OF THE INVENTION

Therefore, the object of the present invention is to provide a mounting element that can eliminate the aforesaid drawbacks of the prior art. According to one aspect of the present invention, there is provided a mounting element adapted for mounting a device on a substrate. The mounting element comprises:
a main body made of metal and having opposite first and second ends, and a soldering portion disposed adjacent to the first end and adapted to be soldered onto the substrate, the second end being adapted for supporting the device thereon, the soldering portion having a roughened outer surface.

According to another aspect of the present invention, there is provided a mounting element adapted for mounting a device on a substrate. The mounting element comprises:
a main body made of metal, extending along an axis, and having first and second ends opposite to each other along the axis, a threaded hole extending from the second end toward the first end, and a soldering portion disposed between the threaded hole and the first end and adapted to be soldered onto the substrate, the second end being adapted for supporting the device thereon, the soldering portion having a knurled inner surface with at least one ridge that extends obliquely with respect to the axis of the main body.

According to a further aspect of the present invention, a circuit board device comprises:
a substrate; and
a mounting element adapted for mounting a device on the substrate and including
   a main body made of metal and having opposite first and second ends, and a soldering portion disposed adjacent to the first end and soldered onto the substrate, the second end being adapted for supporting the device thereon, the soldering portion having a roughened outer surface.

According to still another aspect of the present invention, a circuit board device comprises:
a substrate; and
a mounting element adapted for mounting a device on the substrate and including
   a main body made of metal, extending along an axis, and having first and second ends opposite to each other along the axis, a threaded hole extending from the second end toward the first end, and a soldering portion disposed between the threaded hole and the first end and soldered onto the substrate, the second end being adapted for supporting the device thereon, the soldering portion having a knurled inner surface with at least one ridge that extends obliquely with respect to the axis of the main body.

### BRIEF DESCRIPTION OF THE DRAWINGS

Other features and advantages of the present invention will become apparent in the following detailed description of the preferred embodiments with reference to the accompanying drawings, of which:

FIG. 1 illustrates a circuit board provided with conventional mounting elements for mounting a heat sink on the circuit board;

FIG. 2 is a fragmentary, partly sectional, schematic side view showing the circuit board assembled with the heat sink;

FIG. 3 is a fragmentary, partly sectional, schematic side view showing assembly of a circuit board and a heat sink by means of another conventional mounting elements;

FIG. 4 is a perspective showing the first preferred embodiment of a mounting element according to the present invention to be soldered onto a circuit board;

FIG. 5 is a partly cutaway perspective view showing the second preferred embodiment of a mounting element according to the present invention to be soldered onto a circuit board; and

FIG. 6 is perspective view showing the third preferred embodiment of a mounting element according to the present invention to be soldered onto a circuit board.

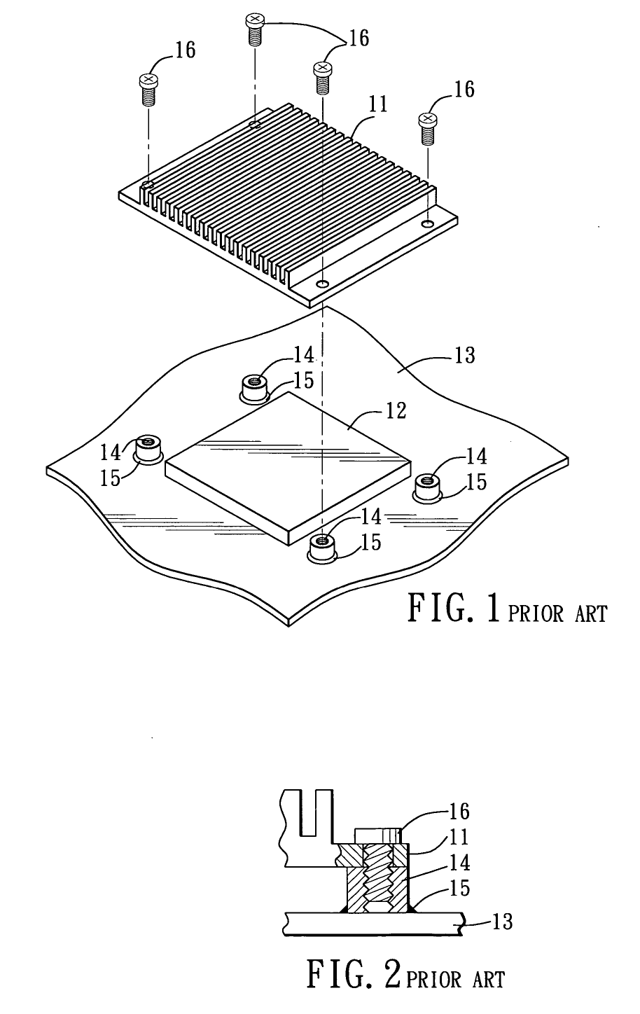

### DETAILED DESCRIPTION OF THE PREFERRED EMBODIMENTS

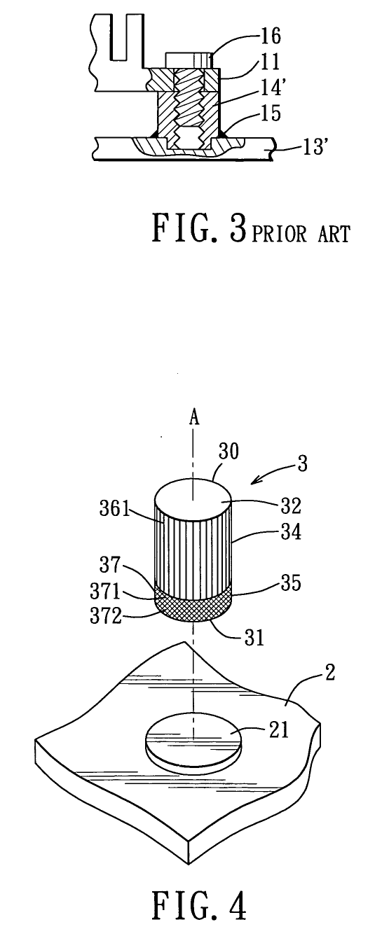

Before the present invention is described in greater detail, it should be noted that like elements are denoted by the same reference numerals throughout the disclosure. Referring to FIG. 4, the first preferred embodiment of a mounting element 3 according to the present invention is adapted for mounting a device (not shown) on a substrate, such as a circuit board 2. In this embodiment, the circuit board 2 is coated with a solder paste 21. The mounting element 3 includes a main body 30.

The main body 30, which is made of metal, extends along an axis (A), and has first and second ends 31, 32 opposite to each other along the axis (A), a soldering portion 35 disposed adjacent to the first end 31 and adapted to be soldered onto the solder paste 21 on the circuit board 2, and a clamping portion 34 disposed between the second end 32 and the soldering portion 35. In this embodiment, the clamping portion 34 has an outer surface formed with a plurality of ridges 361 that extend parallel to the axis (A) of the main body 30. The soldering portion 35 has a roughened outer surface 37. In this embodiment, the roughened outer surface 37 is a knurled surface having two sets of ridges 371, 372 that extend obliquely with respect to the axis (A) of the main body 30 and that intersect each other. The main body 3 is a cylindrical body in this embodiment.

During the assembly operation of the mounting element 3, the mounting element 3 is disposed on the solder paste 21 on the circuit board 2 such that, after passing through a solder furnace, the mounting element 3 is thus fixed on the circuit board 2. It is noted that, due to the presence of the ridges 371, 372, which do not extend parallel to the axis (A) of the main body 30, the solder paste 21 can stick firmly onto the outer surface 37 of the soldering portion 35 such that the mounting element 3 of this invention can be securely mounted on the circuit board 2.

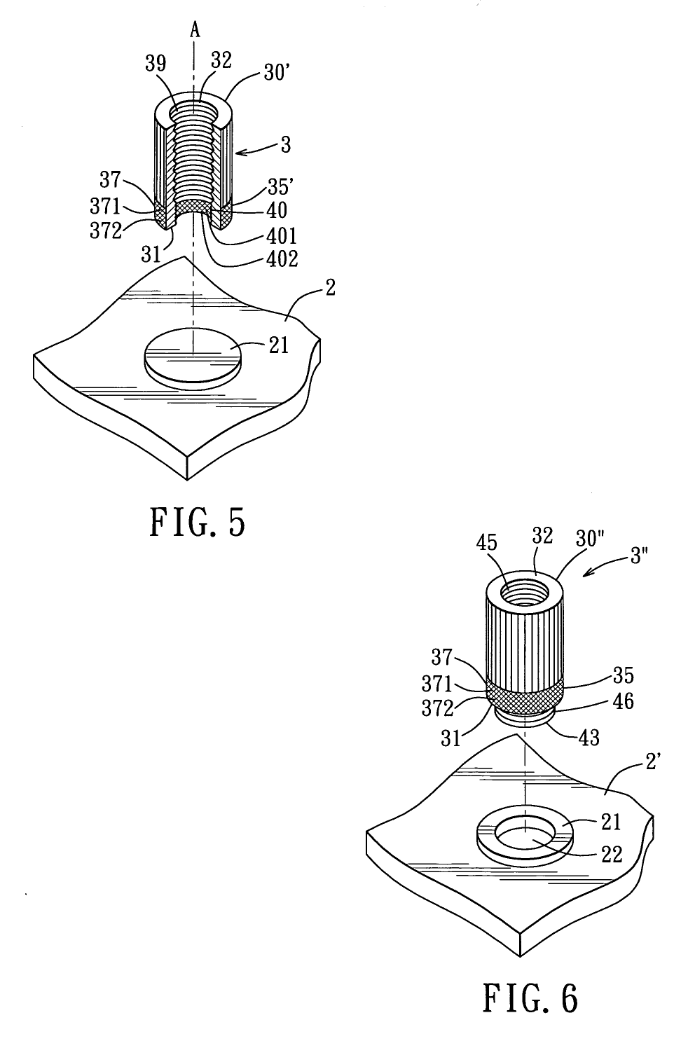

FIG. 5 illustrates the second preferred embodiment of amounting element 3′ for mounting a device (not shown) on a circuit board 2 according to this invention, which is a modification of the first preferred embodiment. Unlike the previous embodiment, the main body 30′ is formed with a fastener hole extending from the second end 32 toward the first end 31 and adapted for extension of a fastener, such as a screw, thereinto. In this embodiment, the fastener hole is a threaded hole 39, which is a through hole. The soldering portion 35′ is disposed between the threaded hole 39 and the first end 31, and is adapted to be soldered onto the circuit board 2. In this embodiment, the soldering portion 35′ further has a knurled inner surface 40, similar to the outer surface 37, with two sets of ridges 401, 402 that extend obliquely with the respect to the axis (A) of the main body 30′ and that intersect each other. Due to the presence of the ridges 371, 372, 401, 402, the solder paste 21 can stick firmly onto the outer and inner surfaces 37, 40 of the soldering portion 35′ such that the mounting element 3′ of this invention can be securely mounted on the circuit board 2.

FIG. 6 illustrates the third preferred embodiment of a mounting element 3″ for mounting a device (not shown) on a circuit board 2′ according to this invention, which is a modification of the second preferred embodiment. Unlike the previous embodiment, the threaded hole 45 is a blind hole. The mounting element 3″ further includes an anchor body 43 extending from the first end 31 of the main body 30″. In this embodiment, the anchor body 43 has a ridged outer surface 46. The anchor body 43 is adapted to extend into a recess 22 in the circuit board 2′. Due to the presence of the ridges 371, 372 and the anchor body 403, the solder paste 21 can stick firmly on the outer surface 37 of the soldering portion 35 and the ridged outer surface 46 of the anchor body 43 such that the mounting element 3″ of this invention can be securely mounted on the circuit board 2′.

While the present invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

1. A mounting element adapted for mounting a device on a substrate, said mounting element comprising:
a main body made of metal and having opposite first and second ends, and a soldering portion disposed adjacent to said first end and adapted to be soldered onto the substrate, said second end being adapted for supporting the device thereon, said soldering portion having a roughened outer surface.

2. The mounting element as claimed in claim 1, wherein said main body is formed with a fastener hole extending from said second end toward said first end.

3. The mounting element as claimed in claim 2, wherein said fastener hole is a threaded hole.

4. The mounting element as claimed in claim 3, wherein said threaded hole is a through hole.

5. The mounting element as claimed in claim 3, wherein said threaded hole is a blind hole.

6. The mounting element as claimed in claim 1, further comprising an anchor body extending from said first end of said main body.

7. The mounting element as claimed in claim 6, wherein said anchor body has a ridged outer surface.

8. The mounting element as claimed in claim 1, wherein said main body defines an axis, and said roughened outer surface is a knurled surface having at least one ridge that extends obliquely with respect to said axis of said main body.

9. The mounting element as claimed in claim 8, wherein said knurled surface includes two sets of said ridges that extend obliquely with respect to said axis of said main body and that intersect each other.

10. A mounting element adapted for mounting a device on a substrate, said mounting element comprising:
a main body made of metal, extending along an axis, and having first and second ends opposite to each other along said axis, a threaded hole extending from said second end toward said first end, and a soldering portion disposed between said threaded hole and said first end and adapted to be soldered onto the substrate, said second end being adapted for supporting the device thereon, said soldering portion having a knurled inner surface with at least one ridge that extends obliquely with respect to said axis of said main body.

11. A circuit board device comprising:
a substrate; and
a mounting element adapted for mounting a device on said substrate and including
a main body made of metal and having opposite first and second ends, and a soldering portion disposed adjacent to said first end and soldered onto said substrate, said second end being adapted for supporting the device thereon, said soldering portion having a roughened outer surface.

12. The circuit board device as claimed in claim 11, wherein said main body is formed with a fastener hole extending from said second end toward said first end.

13. The circuit board device as claimed in claim 12, wherein said fastener hole is a threaded hole.

14. The circuit board device as claimed in claim 13, wherein said threaded hole is a through hole.

15. The circuit board device as claimed in claim 13, wherein said threaded hole is a blind hole.

16. The circuit board device as claimed in claim 11, wherein said mounting element further includes an anchor body extending from said first end of said main body.

17. The circuit board device as claimed in claim 16, wherein said anchor body has a ridged outer surface.

18. The circuit board device as claimed in claim 11, wherein said main body defines an axis, and said roughened outer surface is a knurled surface having at least one ridge that extends obliquely with respect to said axis of said main body.

19. The mounting element as claimed in claim 18, wherein said knurled surface includes two sets of said ridges that extend obliquely with respect to said axis of said main body and that intersect each other.

20. A circuit board device comprising:
a substrate; and
a mounting element adapted for mounting a device on said substrate and including
a main body made of metal, extending along an axis, and having first and second ends opposite to each other along said axis, a threaded hole extending from said second end toward said first end, and a soldering portion disposed between said threaded hole and said first end and soldered onto said substrate, said second end being adapted for supporting the device thereon, said soldering portion having a knurled inner surface with at least one ridge that extends obliquely with respect to said axis of said main body.
